(19) United States
(12) Patent Application Publication
(10) Pub. No.: US 2007/0126157 A1
(43) Pub. Date: Jun. 7, 2007

(54) Apparatus and methods for removing printed articles from a 3-D printer

(75) Inventor: James F. Bredt, Watertown, MA (US)

Correspondence Address: GOODWIN PROCTER LLP;PATENT ADMINISTRATOR, EXCHANGE PLACE, BOSTON, MA, 02109-2881, US

(73) Assignee: Z Corporation, Burlington, MA (US)

(21) Appl. No.: 11/606,960

(22) Filed: Nov. 30, 2006

Related U.S. Application Data
(60) Provisional application No. 60/741,573, filed on Dec. 2, 2005.

(51) Int. Cl. B29C 41/42

(52) U.S. Cl. 264/334; 425/375

(57) ABSTRACT

The invention relates to methods and apparatus for removing finished articles from a powder-based rapid prototyping system. In particular, the invention relates to extracting a printed article from a powder bed in a build chamber of a three-dimensional printer by using a mechanism adapted for displacing the article by at least one of pushing the article at least partially out of the powder bed, pulling the article at least partially out of the powder bed, or changing a boundary of the build chamber to move at least a portion of the unbound powder away from the article.

### CROSS-REFERENCE TO RELATED APPLICATIONS

This application claims the benefit of and priority to U.S. Provisional Patent Application Ser. No. 60/741,573, filed on Dec. 2, 2005, the entire disclosure of which is incorporated herein by reference.

### FIELD OF THE INVENTION

This invention relates generally to rapid prototyping techniques and, more particularly, to extracting finished articles from a rapid prototyping machine.

### BACKGROUND

The field of rapid prototyping involves the production of prototype articles and small quantities of functional parts, as well as structural ceramics and ceramic shell molds for metal casting, directly from computer-generated design data.

Two well-known methods for rapid prototyping include a selective laser sintering process and a liquid-binder 3D printing process. These techniques are similar, to the extent that they both use layering techniques to build three-dimensional articles. Both methods form successive thin cross-sections of the desired article. The individual cross-sections are formed by bonding together adjacent grains of a granular material on a generally planar surface of a bed of the granular material. Each layer is bonded to a previously formed layer to form the desired three-dimensional article at the same time as the grains of each layer are bonded together. The laser-sintering and liquid-binder techniques are advantageous, because they create parts directly from computer-generated design data and can produce parts having complex geometries. Moreover, 3D printing can be quicker and less expensive than machining of prototype parts or production of cast or molded parts by conventional “hard” or “soft” tooling techniques that can take from a few weeks to several months to complete, depending on the complexity of the item.

One example of an early 3D printing technique is described in U.S. Pat. No. 5,204,055 to Sachs et al., the entire disclosure of which is hereby incorporated by reference herein. Generally, in powder-based rapid prototyping, a solid object is fabricated layer-by-layer in a bed of loose powder. The powder is bonded in a sequence of cross-sections, and each section is bonded to the section immediately below in a cyclic process. In the process disclosed in U.S. Pat. No. 5,204,055, the bonding mechanism is the application of the liquid binder deposited by an inkjet-type printhead. Alternatively, in selective laser sintering, the bonding is performed by a focused laser melting or sintering grains of powder.

Typically, the aforementioned rapid prototyping machines include a build box or chamber within which the part is built. The box is bounded on the bottom by a moveable piston (generally referred to as a build table or build surface). Loose, unbound powder is spread into the build box by a leveling mechanism, for example a roller, and the bonding proceeds for a thin layer. At the completion of a given layer, the piston at the bottom of the build box is indexed downwards, creating a space to receive the next layer of powder.

The parts fabricated in this manner can be relatively fragile after fabrication, in particular before any post-processing operation is performed on the part. Additionally, the parts are surrounded intimately by unbound powder, from which the part must be extracted. These factors can make removing the finished part from the build box difficult, especially without damaging the part.

In molding or casting processes, the completed parts are cradled in mold portions with release agents and draft angles and may be removed by ejecting the part from the mold with one or more ejection pins. Additionally, these parts are typically not as fragile as a part manufactured by three-dimensional printing from powders and are not completely encapsulated by unbound powder, which can interfere with the removal of the part. Further, the removal of parts from powder-based printers can, for example, result in powder getting into sensitive components of the rapid prototyping system, thereby adversely impacting the operation of the system. In addition, disturbing the powder bed can cause the powder to become airborne forming clouds that can contaminate the work environment.

There is, therefore, a need for methods and apparatus for removing finished articles from a powder-based rapid prototyping system with ease and without damaging the finished part.

### SUMMARY

The present invention is directed to apparatus and methods for removing finished articles from a powder-based rapid prototyping system, such as, for example, a three-dimensional printer or a selective laser sintering machine. The apparatus and methods can be built as part of a new three-dimensional printer or can be adapted to be retrofit and work within standard three-dimensional printers.

Generally, the apparatus and methods involve the use of an extraction or ejection mechanism that is adapted to ride on or with a piston that moves within a build chamber to raise and lower a build surface. The mechanism is adapted to automatically push or pull a finished article from the build chamber. The mechanism typically occupies an area over the build surface less than the footprint of the build surface. The mechanism is also typically separate from the build surface, as the build piston forming the build surface seals against the walls of the build chamber and the mechanism moves relative to the build surface to allow any unused powder to slip past the finished part and the mechanism. The mechanism can be used with a variety of three-dimensional printers, including those described in U.S. Patent Publication No. 2004/0265413 and U.S. Patent Publication No. 2005/0280185, the entire disclosures of which are hereby incorporated by reference herein.

The chamber in use is progressively filled with powder deposited by a layering mechanism. The mechanism can be provided with seals to prevent leakage of loose powder from the bottom of the build chamber. Additionally, the mechanism can be adapted to move freely through the loose powder that surrounds the part(s) and ensnare the part produced during the printing process. The mechanism does not need to reside within a special depression or mating fixture within the chamber, but it is desirable for the mechanism to be sufficiently structurally stable, so that powder spread during printing does not shift because of uncoordinated movement of the mechanism as the mechanism rides along with the build surface.

The invention can incorporate various types of mechanisms into the build chamber, for example a set of pins that ride along with the build surface/piston during the part building process, to aid in the extraction of the completed articles. Additionally or alternatively, the invention can include a build chamber whose boundaries can be adjusted to allow unbound powder to move away from the printed article.

In one aspect, the invention relates to an apparatus for extracting an article from a powder bed in a build chamber of a three-dimensional printer. The apparatus includes a mechanism adapted for use with the three-dimensional printer and disposed at least partially within the build chamber and adapted for displacing the article comprising bound powder from the powder bed comprising unbound powder. The mechanism works by at least one of pushing the article at least partially out of the powder bed, pulling the article at least partially out of the powder bed, and/or changing a boundary of the build chamber to move at least a portion of the unbound powder away from the article, or combinations thereof.

In another aspect, the invention relates to a method of extracting an article from a powder bed in a build chamber of a three-dimensional printer. The method includes the steps of displacing the article comprising bound powder from the powder bed comprising unbound powder by employing a mechanism adapted for use with the three-dimensional printer and disposed at least partially within the build chamber, and removing the article from the three-dimensional printer. The mechanism works to at least one of push the article at least partially out of the powder bed, pull the article at least partially out of the powder bed, and/or change a boundary of the build chamber to move at least a portion of the unbound powder away from the article, and/or combinations thereof.

In various embodiments of the foregoing aspects, the pushing mechanism includes at least one of a pin, a basket, a grate, a spoon, and a cradle; the pulling mechanism includes at least one of a sling, a basket, a net, a spoon, and a hook; and the boundary changing mechanism includes at least a movable portion of a wall defining the powder bed. The invention can also include at least one of a flow inducer and a vibrator to fluidize at least a portion of the powder bed, and/or a mechanism for imparting reciprocating or other motion to the article within the powder bed.

In another aspect, the invention relates to an apparatus for removing a printed article from a three-dimensional printer. The apparatus includes a build chamber disposed within the three-dimensional printer, a moveable build surface disposed within the build chamber and adapted for receiving unbound powder, portions of layers of the unbound powder being bonded through the action of the three-dimensional printer to produce the printed article, and an ejection mechanism disposed through at least one of the build surface and a wall of the build chamber. The ejection mechanism can be adapted for movement relative to at least one of the build surface and the wall of the build chamber.

In various embodiments, the ejection mechanism can include a ratchet mechanism for causing the movement of the ejection mechanism relative to at least one of the build surface and the wall of the build chamber. Additionally, the ejection mechanism can include at least one porous surface selected, for example, from the group consisting of a basket, a grate, a wire form, and a mesh fabric. The at least one porous surface can be adapted for releasable attachment to at least one of the build surface and the ejection mechanism by, for example, at least one threaded pin. Further, the apparatus can include a mechanism for removing the porous surface from the build surface. The mechanism can include at least one cable.

In one embodiment, the ejection mechanism can include at least one of an ejector pin, a plurality of ejector pins, a hook, and a spoon. The ejection mechanism can be adapted to move independent of the build surface. In one embodiment, the ejection mechanism is adapted to move in conjunction with the build surface when the build surface is moved beyond a predetermined height, and remain moveably fixed in space when the build surface is lowered below the predetermined height. The printed article is supported by the ejection mechanism upon downward vertical movement of the build surface.

In additional embodiments, the ejection mechanism defines at least one air channel, where the at least one air channel can be adapted to eject air from a region of the ejection mechanism towards the printed article or to draw a vacuum to remove unbound powder. The ejection mechanism itself can be adapted to support a porous surface, such as, for example, a basket, a grate, a wire form, a sling, a cradle, and a mesh fabric. The porous surface can be adapted to support the printed article.

Additionally, the build chamber can be disposed around the moveable build surface and include at least one moveable wall. The moveable build surface is adapted to move relative to the build chamber. In one embodiment, the at least one wall is separable from the moveable build surface to allow unbound powder to exit the chamber. The at least one wall can be pivotably mounted to the apparatus. In additional embodiments, the apparatus can include a collection chamber disposed below the build surface for receiving the powder exiting from the build chamber. In further embodiments, the apparatus can include printed forms disposed on the ejection mechanism, where the printed forms include complementary surfaces for supporting the printed article.

In another aspect, the invention relates to an apparatus for removing a printed article from a three-dimensional printer. The apparatus includes a build chamber at least partially disposed within the three-dimensional printer, a moveable build surface, and at least one moveable wall. The at least one moveable wall is separable from the build surface to allow unused powder to exit the chamber. The build chamber is adapted for receiving unbound powder for producing the printed article.

In various embodiments, the at least one moveable wall is pivotably mounted to the apparatus. The wall can be planar or include one or more grooves or channels to help direct the flow of unbound powder. The apparatus can include a collection chamber disposed below the build surface for receiving the powder exiting from the build chamber. The apparatus can also include an ejection mechanism disposed through the build surface. In one embodiment, the apparatus includes a ratchet mechanism for causing movement of the ejection mechanism relative to the build surface.

In another aspect, the invention relates to methods for extracting a printed article from a three-dimensional printer. One method includes the steps of supporting the printed article within a build chamber with an ejection mechanism and moving at least one of the ejection mechanism and a build surface relative to the other to separate the printed article from unbound powder in the build chamber after the printing process. The build chamber is adapted for receiving unbound powder, portions of layers of the unbound powder being bonded through the action of the three-dimensional printer to produce the printed article. The ejection mechanism can be disposed through the build surface located within the build chamber. An alternative method can include the steps of supporting the printed article within a build chamber and changing at least one boundary of the build chamber to move unbound powder in the build chamber away from the printed article.

In various embodiments, the method includes the step of advancing the ejection mechanism relative to the build surface to advance the printed article beyond a boundary of the build chamber. Further, the method can include directing pressurized air through at least one channel disposed within the ejection mechanism towards the printed article to force unbound powder from the printed article. Alternatively, the method can include drawing a vacuum and extracting unbound powder from an area proximate the printed article through at least one channel disposed within the ejection mechanism. The method can also include the step of printing forms of complementary shape to the article to be printed onto the ejection mechanism to support the printed article. In addition, the ejection mechanism can include a complementary shape for supporting the printed article.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic diagram of an apparatus for rapid prototyping in accordance with one embodiment of the invention;

FIG. 2 is a schematic perspective view of a three-dimensional printer for rapid prototyping in accordance with one embodiment of the invention;

FIG. 3 is a partial cross-sectional side view of a three-dimensional printer adapted for removing a printed article in accordance with one embodiment of the invention;

FIGS. 4A-4F are schematic cross-sectional side views of a portion of a three-dimensional printer with a printed article being printed and removed in accordance with one embodiment of the invention;

FIGS. 5A and 5B are schematic cross-sectional side views of a portion of a three-dimensional printer with a printed article being removed in accordance with an alternative embodiment of the invention;

FIGS. 6A-6C are schematic cross-sectional side views of a portion of a three-dimensional printer with a printed article being removed in accordance with another alternative embodiment of the invention;

FIGS. 7A and 7B are schematic cross-sectional side views of a portion of a three-dimensional printer with a printed article being removed in accordance with another alternative embodiment of the invention;

FIGS. 8A and 8B are schematic cross-sectional side views of a portion of a three-dimensional printer with a printed article being removed in accordance with another alternative embodiment of the invention;

FIGS. 9A and 9B are schematic cross-sectional side views of a portion of a three-dimensional printer with a printed article being removed in accordance with another alternative embodiment of the invention;

FIG. 10A is a schematic cross-sectional side view of a portion of a three-dimensional printer with a printed article being removed in accordance with another alternative embodiment of the invention;

FIG. 10B is a schematic perspective view of a portion of the removal mechanism of FIG. 10A;

FIGS. 11A-11G are schematic cross-sectional side views of a portion of a three-dimensional printer with the removal mechanism of FIGS. 10A and 10B in operation, in accordance with one embodiment of the invention;

FIG. 12A is a schematic perspective view of a portion of an alternative removal mechanism in accordance with one embodiment of the invention; and

FIGS. 12B and 12C are schematic plan views of a portion of the removal mechanism of FIG. 12A in a closed position and an open position, respectively, in accordance with one embodiment of the invention.

### DETAILED DESCRIPTION

In the following, various embodiments of the present invention are described with reference to three-dimensional printers. It is, however, to be understood that the present invention can also be used with other types of powder-based manufacturing processes.

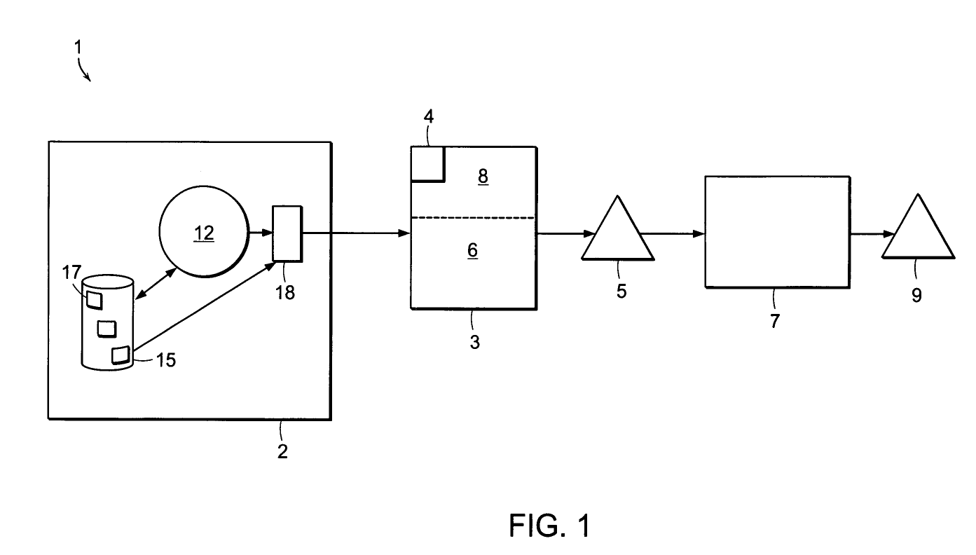

FIG. 1 is a schematic diagram of one example of an apparatus 1 for rapid prototyping in accordance with the invention. As illustrated, there is a computer 2, a three-dimensional printer 3, a formed 3-D part 5, a post processing system 7, and a post-processed 3-D part 9.

The computer 2 may be a personal computer, either a desktop computer or a portable computer. The computer 2 can be a stand-alone computer or a part of a Local Area Network (LAN) or a Wide Area Network (WAN). In accordance with the invention, the computer 2 includes a software application 12, such as a Computer Aided Design (CAD)/Computer Aided Manufacturing (CAM) program 12. The CAD/CAM program 12 manipulates digital representations of three-dimensional objects 17 stored in a data storage area 15. The CAD/CAM program 12 can create, modify, and retrieve the stored representations 17. When a user desires to fabricate a three-dimensional part 5 of the stored object representation 17, the user exports the stored representation to a high-level software program 18. From the high-level program 18, the user then instructs the program 18 to print. The program 18 sections the digital representation 17 into a plurality of discrete two-dimensional layers, each of a predetermined thickness.

The program 18 controls printing of each layer by sending high-level instructions to control electronics 4 in the printer 3 that operate the three-dimensional printer 3. Alternatively, the digital representation of the object 17 can be directly read from a computer-readable medium (e.g., magnetic or optical disk) by printer control hardware. The three-dimensional printer 3 includes a powder material processing area 6 where the printing is performed and a control area 8 where control electronics 4 are housed.

The three-dimensional printer 3 uses an ink jet-type print cartridge to deposit binder solution from the ink jets onto successive layers of a powdered build material, such as disclosed in U.S. Pat. No. 5,902,441, the entire disclosure of which is hereby incorporated by reference herein. Where the binder solution combines with the build powder, the powder binds into a solid structure. By controlling the placement of binder droplets from these binder jets, the solid structure of the 2-D cross section can be physically reproduced. The three-dimensional printer 3 fabricates a physical layer for each sectioned layer provided by the program 18. When the geometry file has been completely printed, a three-dimensional part 5 is formed. Further details of binding a powder to form an object are disclosed in U.S. Pat. Nos. 5,340,656 and 5,387,380, the entire disclosures of which are hereby incorporated by reference herein.

The post-processing system 7 can be used to apply various finishing options to the part 5, as necessary to achieve a specific end result. Post processing can include heating, cooling, painting, dipping, or otherwise infiltrating the article with a material to further strengthen the part or provide other structural or functional characteristics.

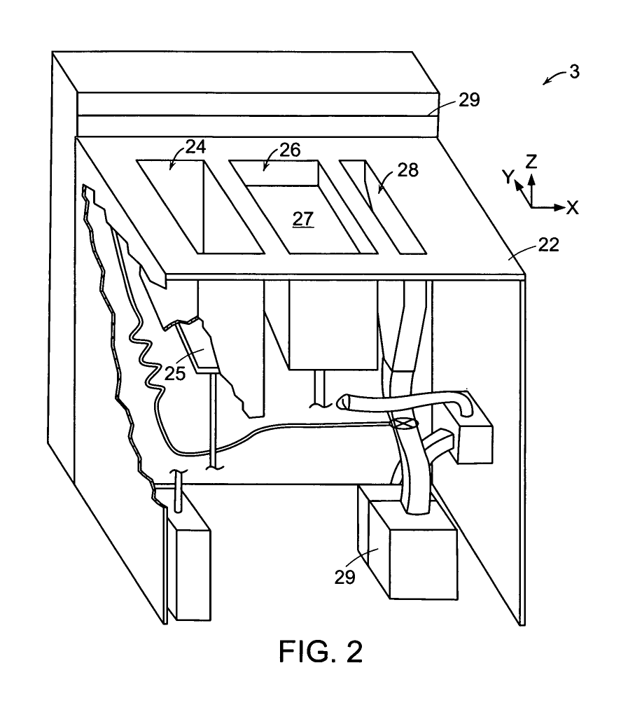

FIG. 2 depicts one example of a three-dimensional printer 3. The printer 3 includes a feed reservoir 24, a build chamber 26, and an overflow cavity 28 depressed in a top deck 22 of the printer 3. A supply of build powder can be supported in the feed reservoir 24 by a movable feed piston 25 and a movable build surface 27 is shown within the build chamber 26. The feed piston 25 can move incrementally upward in the z-axis during operation, while the build surface 27 can move incrementally downward in the z-axis. A constant airflow down the overflow cavity 28 can be created by an optional vacuum pump/filtration system 29.

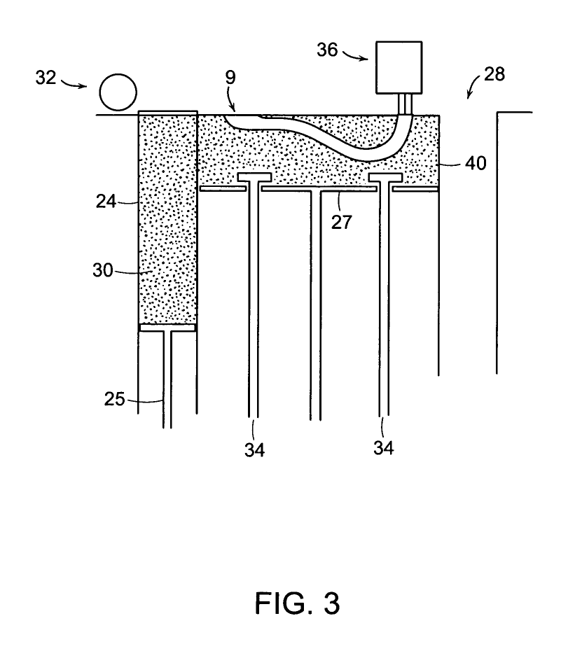

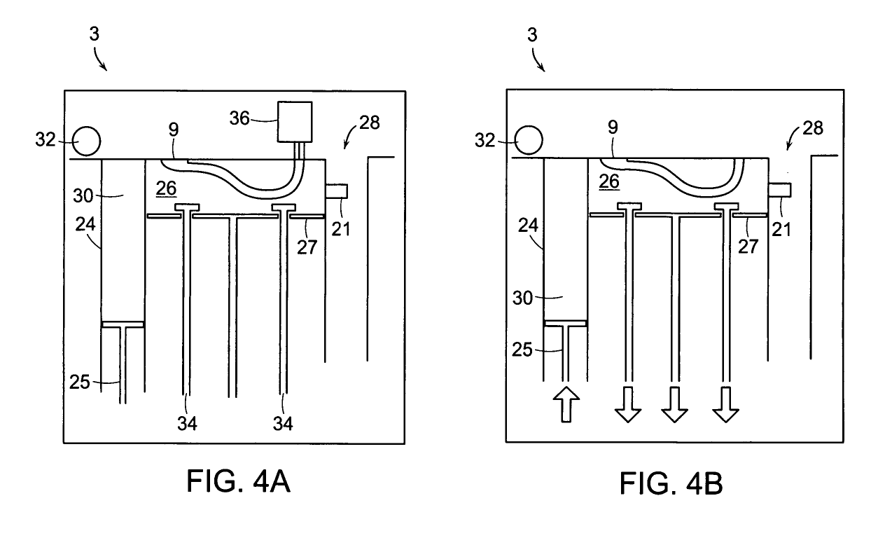

Referring to FIG. 3, the feed piston/floor 25 of the feed reservoir 24 has been positioned such that a sufficient quantity of build material 30 for one layer protrudes above the feed reservoir 24. The build surface 27 has been positioned to a specific depth to receive one layer of build material 30. During operation, the build surface 27 is incrementally lowered to create a plurality of successive build layers. Also shown in FIG. 3 is a roller 32 for spreading the build material 30, a printhead 36 for depositing binder onto the build material 30, and an ejection mechanism 34 for extracting a finished part from the three-dimensional printer 3. The operation of the three-dimensional printer 3 is discussed in greater detail with respect to FIGS. 4A-4F.

FIGS. 4A to 4F depict building and extracting a finished article from a rapid prototyping machine. Generally, in a normal machine cycle, as shown in FIGS. 4A-4C, an inkjet printhead 36 dispenses liquid binder over the powder build material 30 in a defined pattern (FIG. 4A) and, subsequently, the build surface 27 is lowered while the feed piston 25 is raised (FIG. 4B), at which point the roller 32 spreads the build material 30 over the previously printed layer to form the printing surface for the next layer (FIG. 4C). These steps are repeated until the part is complete, as shown in FIG. 4D. A period of curing and strengthening may be required before extraction of the part, depending on the powder and binder used.

FIGS. 4E and 4F depict a basic implementation of the extraction portion of the invention. As shown in FIG. 4E, the ejector pins 34a, 34b are held fixed to support the part 9 in the upper half of the build chamber 26, while the build surface 27 is lowered still further, creating space for unbounded powder to drain into, thereby exposing the part 9. In FIG. 4F, the pins 34a, 34b can be raised and lowered selectively to facilitate powder movement around the part 9, and emptying of internal cavities. When the part 9 is substantially free from the unbound powder, it can be removed for further cleaning and finishing. While only two ejector pins 34a, 34b are depicted, as can be readily appreciated, any number of pins in any arrangement can be provided, including a single pin.

More specifically, FIG. 4A depicts the machine 3 printing a cross-sectional layer of the part by depositing binder solution on a freshly spread layer of build material 30. As shown in FIG. 4B, the feed piston 25 is raised to make another layer's worth of material available to the roller 32, while the build surface 27 is lowered to receive the next layer of build material 30. The roller 32 is then advanced while counter rotating to its forward motion (arrow 38) to push a quantity of build material 30 forward toward the build chamber 26. As illustrated in FIG. 4C, the roller 32 continues across the build chamber 26 to spread evenly a finite layer of build material 30 onto the build surface 27. To assure that a full build layer is deposited on the build surface 27, an excess amount of build material 30 is provided by and removed from the feed reservoir 24. This excess build material is deposited by the roller 32 into the optional overflow cavity 28, where the airflow carries the particles to the optional vacuum/filtration system 29 (FIG. 2).

Having provided a fresh powder layer with movement of the roller 32 in the x-direction, the 2-D cross-section of that layer can be printed. In particular, the printing occurs during successive passes of the printhead 36 in the y-direction during the reverse pass of the gantry, on which the printhead 36 is mounted, in the negative x-direction. Other three-dimensional printing methods can also be used.

FIG. 4D depicts a part 9 completed by the three-dimensional printer 3. The finished part 9 is embedded in and completely or substantially encapsulated by unbound powder. The finished part 9 can be removed by pushing or pulling the part 9 out of the build chamber and surrounding powder or by changing a boundary of the build chamber 26 to move the powder away from the finished part 9.

As shown in FIGS. 4E and 4F, the part 9 can be extracted by both changing a boundary of the build chamber and pushing the part 9 out of the unused powder. To remove the finished part 9 from the surrounding unbounded powder 40, the build surface 27 is lowered (thereby changing a boundary of the build chamber), while the extraction mechanism 34 holds the part 9 in place. This allows the unused or unbound powder build material 30 to fall away from the finished part 9. In the embodiment shown and as described hereinabove, the extraction mechanism 34 is a pair of ejector pins 34a, 34b that extend through the build surface 27. As the build surface 27 is lowered and the unused powder 40 falls away, the finished article comes to rest on the ejector pins 34a, 34b, which support the part 9 within the build chamber 26. The unused powder 40 falls into the space created under the part 9 when the table 27 is lowered, thereby exposing the finished part 9. In various other embodiments, as described in greater detail hereinbelow, the extraction mechanism can include a porous surface for supporting the finished part 9 or printed forms having a shape complementary to the finished part 9.

Additionally, various mechanisms can be used to aid in the separation of the part 9 from the unbound powder. In one embodiment, various means 21 can be used to fluidize the powder, thereby making the powder fall away from the part 9 more easily. For example, a shaker coupled to the build chamber 26 can be energized, so that the resultant vibrations imparted on the build chamber 26 fluidize the powder. In another example, an auger or other type of stirring mechanism can be used in the powder bed to fluidize the powder after printing to maintain the powder in a fluidic state. The powder bed, however, must be maintained in a stable state to prevent, for example, the collapse of the powder bed supporting the part during printing. Further, various techniques can be employed to impart a reciprocating motion to the finished part 9 to help free the part 9 from the unbound powder, for example the selective movement of the pins 34a, 34b. Further still, additional ejection or support pins can be used, with the additional pins extending through the sidewalls of the build chamber 26.

In order to collect smaller parts from the build chamber 26, such as parts that are smaller than the distance between the ejector pins, a basket can be woven or provided between the pins using a coil-spring. Alternatively or additionally, other types of porous surfaces can be used. One advantage of using a porous surface is that unbound powder sifts readily through the pores (e.g., the wires in the basket), leaving the part 9 caught and exposed. The process of part extraction can be further facilitated by reciprocating, twisting, or jiggling the ejector pins to help the unused powder 40 flow around the part 9 and through the pores.

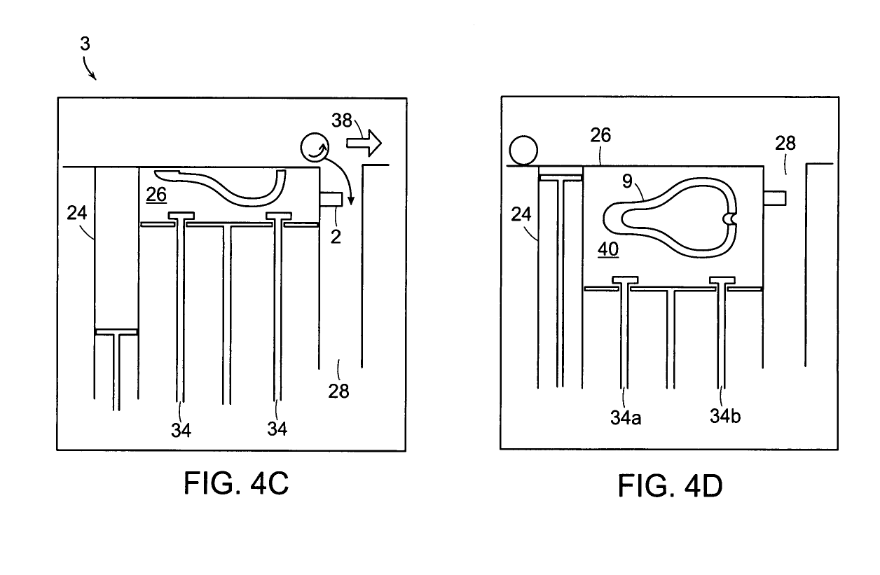

More specifically, FIGS. 5A and 5B depict a three-dimensional printer 3 with such an alternative extraction mechanism 34. The mechanism 34 includes a porous surface 35 that can include, for example, a basket woven over the ejector pins 34a, 34b, or a removable net attached to the pins 34a, 34b, or a framework supported by the pins 34a, 34b. Depending on the size and shape of the part 9, the porous surface 35 may provide better support to the fragile part 9 while removing the part 9 from the printer 3. The porous surface 35 can be used to push and/or pull the finished part 9 out of the unbound powder 40. Other possible porous surfaces include a grate, a screen, a cradle, a hook, a spoon, a rake, a wireform (including a looped wire), or combinations thereof. The porous surface 35 may be relatively rigid, compliant, flexible, elastic, or other, as suited for a particular purpose.

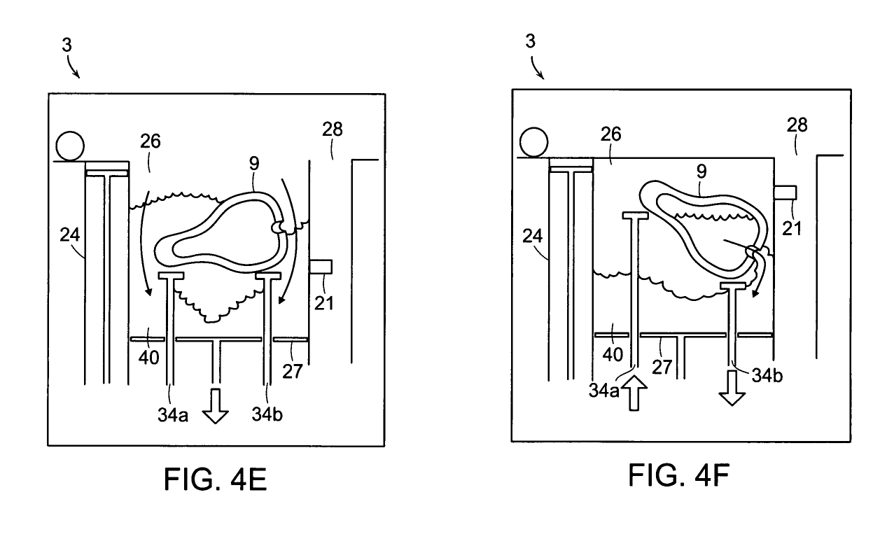

Yet another alternative embodiment of an extraction mechanism 34 is depicted in FIGS. 6A-6C. The extraction mechanism 34 is a net fixed securely to the build surface 27 during part manufacturing. The net is fixed to prevent the powder from shifting or collapsing during the build, causing dimensional or geometric errors in the manufactured part. In this embodiment, the net or a flexible basket can be fixed to the build surface 27 by threaded nuts 39 at the corners of the build chamber 26. The nuts 39 are threaded into the ends of pins 41 in the build surface 27 that act as anchors, rather than ejectors. The nuts 39 can be directly attached to the net or can be separate components. As the build proceeds, cables 37 that are attached to the porous surface (for example, the corners of a rectangular grate) are drawn up and down over the corners of the upper edge 43 of the build chamber 26. They may be kept below the spreading mechanism by an appropriate tensioning mechanism (e.g., one or more weights 31 secured to the ends of the cables 37), as shown in FIG. 6A. At the completion of the build, the anchor pins 41 are rotated (FIG. 6B) to unscrew from the nuts 39 and detach the corners of the net 34. As shown in FIG. 6C, the cables 37 attached to the corners may be lifted manually to withdraw the part from the build chamber 26. Alternatively or additionally, the cables 37 could be automatically retracted by, for example, a small scale motor and winch combination, to raise the finished part 9 out of the build chamber 26. Further, the ends of the cables 37 could be fixed at the maximum depth of the build surface 27 to produce the finished part 9. Further lowering of the table 27 will effectively withdraw the part 9 from the unbound powder 40.

In alternative embodiments, the net or other porous surface can be secured in the build chamber 26 by, for example, a radial peg in the anchor pins 41 seated in slotted holes on the nuts 39, or other mechanical fastening means. Generally, the fastening means should be a relatively coarse arrangement so that powder filtering into the threads or slots will not cause the nuts to seize to the anchors.

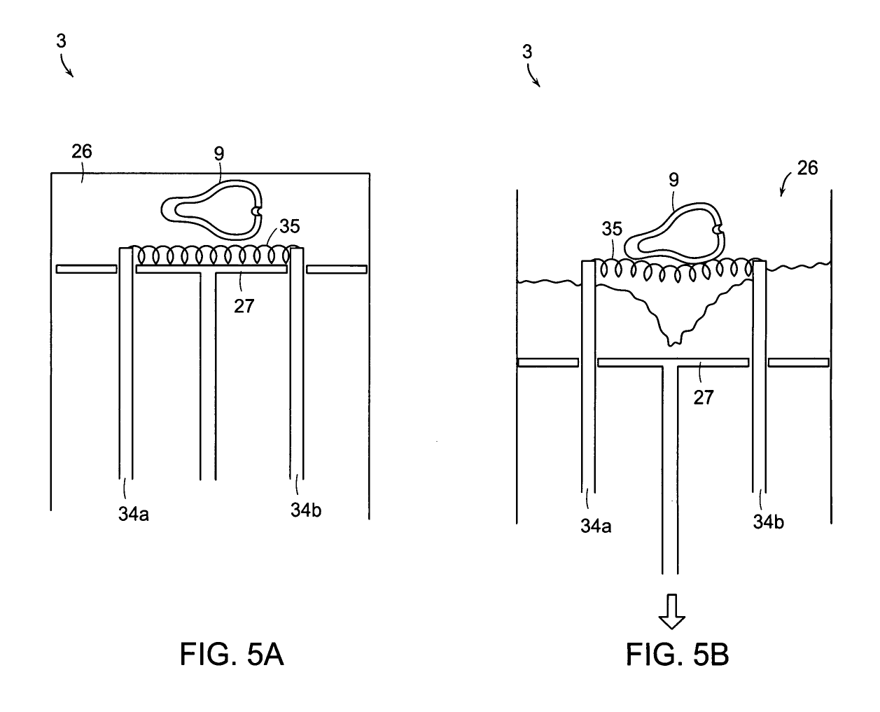

To prevent damage of the finished part 9 by the force from the ejector pins described with respect to FIGS. 4A-4F, it may be desirable to three-dimensionally print a supporting frame that cradles the part from underneath, thereby redistributing the force of the pins over a greater area of the part 9. See FIGS. 7A and 7B. The supporting structure 50 is printed as a separate component in the build and slightly spaced from the part 9, so it can be easily separated from the part 9 after the part 9 is extracted. In one embodiment, the support structure 50 is printed directly onto the ejection mechanism 34. To further facilitate mechanical agitation of the part during extraction, it is possible to build a structure of interlocking parts 52, 54 within the support structure 50. Each component in the assembly is separated by loose powder that permits a degree of sliding freedom between the components 9, 50, 52, 54. As illustrated in FIG. 7B, the support structure 50, 52, 54 can rock to accommodate the transition from the linear up and down motion of the ejector pins 34a, 34b to a rocking motion of the part 9 and cradle 54. Additionally or alternatively, other mechanisms, such as, for example, rollers, levers, linkages, and combinations thereof, can also be constructed as needed by the three-dimensional printer. Naturally, pre-printed or supporting frames manufactured by other methods can be provided to speed printing of the part 9.

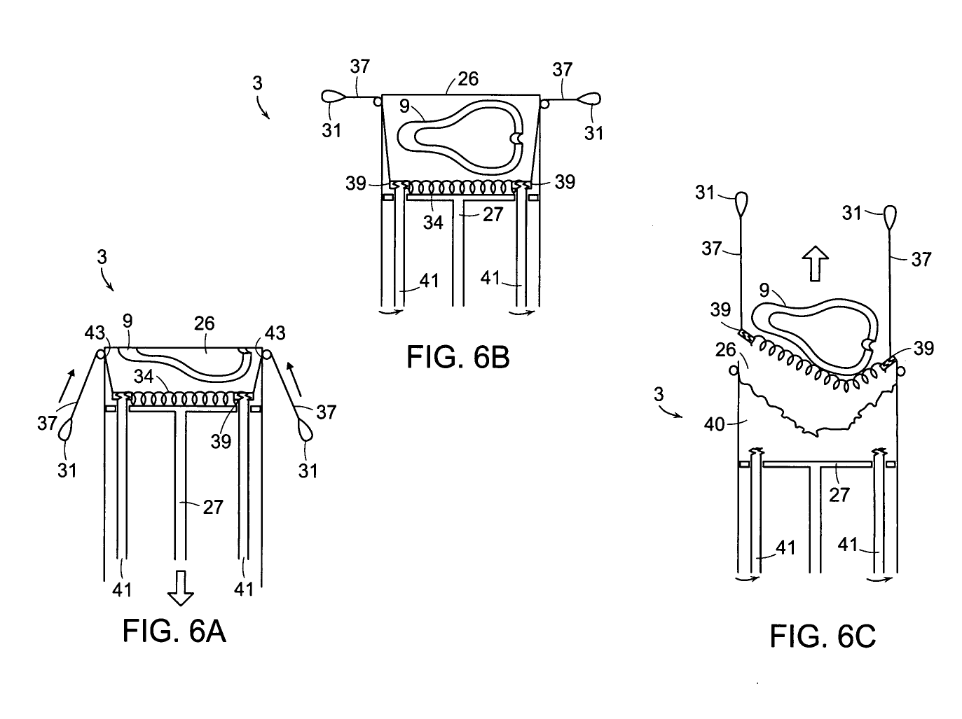

Many powdered materials, including those used in three-dimensional printing, possess a certain amount of internal friction that inhibits flow. To facilitate flow of the loose powder around the part during extraction, the ejector pins 34a, 34b can be hollow, with nozzles 56 in their tips 58, as shown in FIG. 8A. When placed in contact with an air source 60 (for example, compressed air), the air emerging from the tips 58 of the pins 34a, 34b will fluidize the loose powder in the build chamber 26 and speed the drainage of powder 40 from around the part 9. In one embodiment, the air source 60 can come from the optional vacuum/filtration system and be supplied to the ejection mechanism via a system of valves and tubing. The flow can be intermittent and cycle around from one pin 34a to the other 34b. Further, a source of air will aid in the creation of the empty space beneath the part 9 while the build surface 27 is lowered and the pins 34a, 34b support the part 9.

In one embodiment, the air source 60 is a vacuum source, where the vacuum is used to remove unbound powder 40 surrounding the finished part 9. The use of vacuum in conjunction with the various ejection mechanisms described herein may prevent the powder 40 from becoming airborne in a user's work area or from contaminating any sensitive components of the printer 3. Additionally, the vacuum source can aid in the recycling of the unbound powder 40. In another embodiment, the air source 60 can alternate between a positive pressure (out flow) and a negative pressure (vacuum) to alternately loosen and remove unbound powder 40 from the build chamber 26 and part 9.

FIG. 8B shows one embodiment of air channels incorporated into the support structure 50, 52, 54 to provide lubrication between sliding joints, as described with respect to FIGS. 7A and 7B above, and to help separate the part 9 from the structure 50, 52, 54, as necessary. As described with respect to FIG. 8A, the ejector pins 34a, 34b can be hollow to allow the passage of air therethrough. As opposed to nozzles located at the tips of the pins 34a, 34b, the printed supports 50, 52, 54 can include passages for directing a flow of air therethrough and into contact with the printed part 9 or between the printed supports 50, 52, 54.

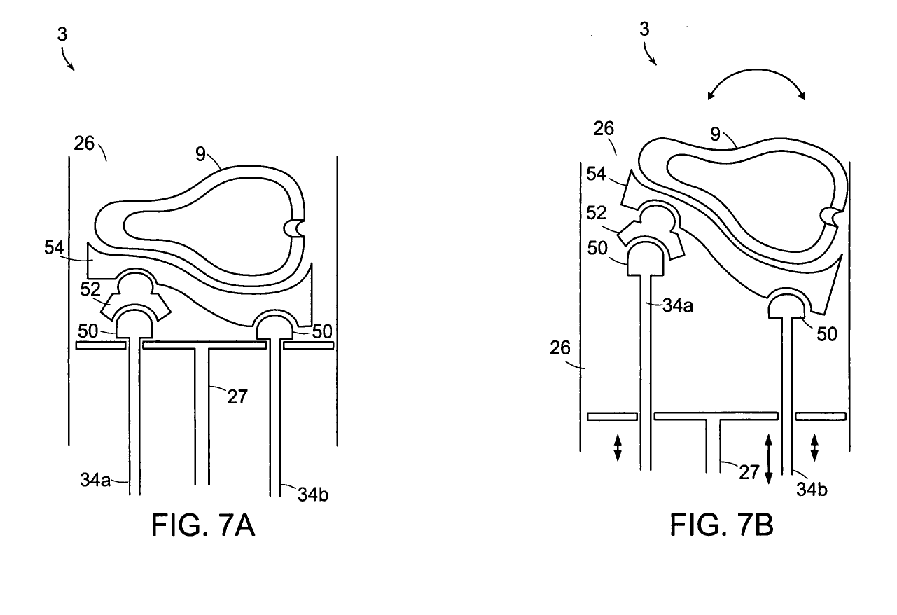

FIGS. 9A and 9B depict an additional embodiment of a three-dimensional printer 103 in accordance with the invention, where the build chamber 126 is designed, in part, to facilitate the drainage of unbound powder 140 from around a finished part 109. In the embodiment shown, the build chamber 126 includes movable side walls 128 that can be mounted to toggling mechanisms 130.

As shown in FIG. 9A, the build chamber 126 is closed with vertical side walls, similar to the printing phase of the part build cycle. In FIG. 9B, after the build cycle is completed, the build chamber 126 opens to allow the unbound powder 140 to flow out of the chamber 126. In the closed configuration, the walls 128 of the build chamber 126 present vertical box walls that are employed to bound the powder during the build process, i.e. printing. In the open configuration, the walls 128 have been toggled up and out. By toggling a wall or otherwise changing a boundary of the chamber 126, at least one diverging channel 132 is presented to the unbound powder 140, thereby giving the powder 140 room to flow and drain from the build chamber 126. Consequently, removal of the part 109 from the chamber 126 becomes easier. Further, by toggling the walls 128 of the build chamber 126 away from the sides of the build surface 127, channels 132 are created through which powder 140 can drain into a collection tray 152 beneath the piston mechanism of the build surface 127 (FIG. 9B).

Depending on the configuration of the build chamber 126 and printer 103, any number of walls of the build chamber 126 can be mounted to toggle mechanisms 130. For example, if the printer machine architecture shown in FIG. 2 is assumed, it may only be possible to toggle the wall 128 that coincides with the overflow chute 28, shown to the right of the chamber 26 in FIG. 2. For a printer that possesses different means of supplying powder, it may be desirable to toggle all walls of a polygonal build chamber with any number of planar walls. It may also be possible for the build chamber 126 to include non-planar (e.g., arcuate) walls that may, for example, help facilitate the drainage of the unbound powder 140; however, it is desirable for the build surface 127 to sealingly engage with the inner surfaces of the walls 128 of the build chamber 126 to maintain integrity and stability of the powder bed and part location during the build cycle.

The toggle mechanism 130 can include any number of mechanical linkages or similar arrangements to open and close the build chamber 126. In the embodiment shown in FIGS. 9A and 9B, a four-bar linkage mounted on two sides is used; however, other types of mechanisms can be used to change a boundary of the build chamber 126 including, for example, sliding, rotating, cam and follower, ball nut and lead screw, threaded, wedged, and telescoping mechanisms. In one embodiment, the build chamber 126 is cylindrical in shape with an arcuate wall that can be moved outwardly from the chamber 126 and slide about the exterior cylindrical surface of the chamber 126 to open the chamber 126 and allow the unbound powder 140 to exit.

Additionally, the ejection pins 134a, 134b depicted in FIGS. 9A and 9B are optional, as changing a boundary of the build chamber 126 is sufficient to substantially separate the finished part 109 from the unbound powder 140 for removal of the part 109. The optional ejection pins 134a, 134b can be used to support the part 109, eject the part 109, or to impart vibration or a reciprocating motion to the part 109. In addition, the ejection pins 134a, 134b or other structure can include air channels to either introduce air into the build chamber 126 or to draw unbound powder out of the build chamber 126, thereby assisting in moving unbound powder 140 away from the finished part 109. Additionally, various other mechanisms can be used to aid in the separation of the part 109 from the unbound powder 140, as described hereinabove with respect to FIGS. 4A-4F.

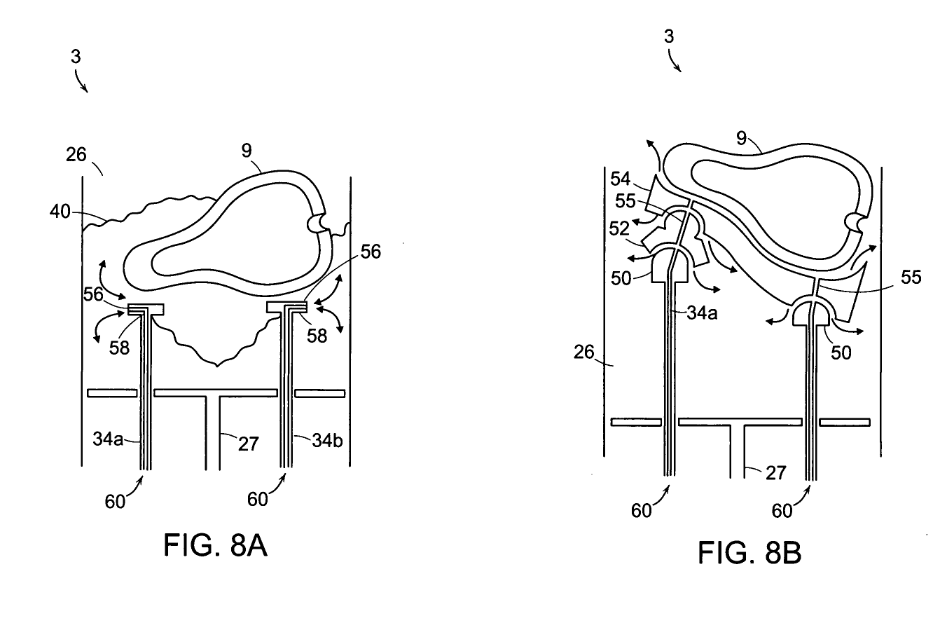

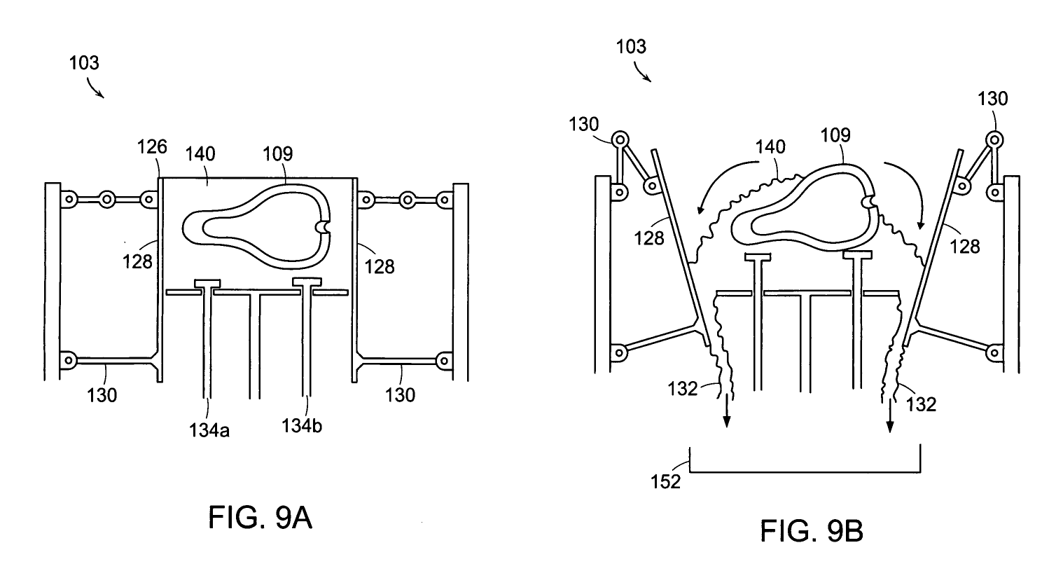

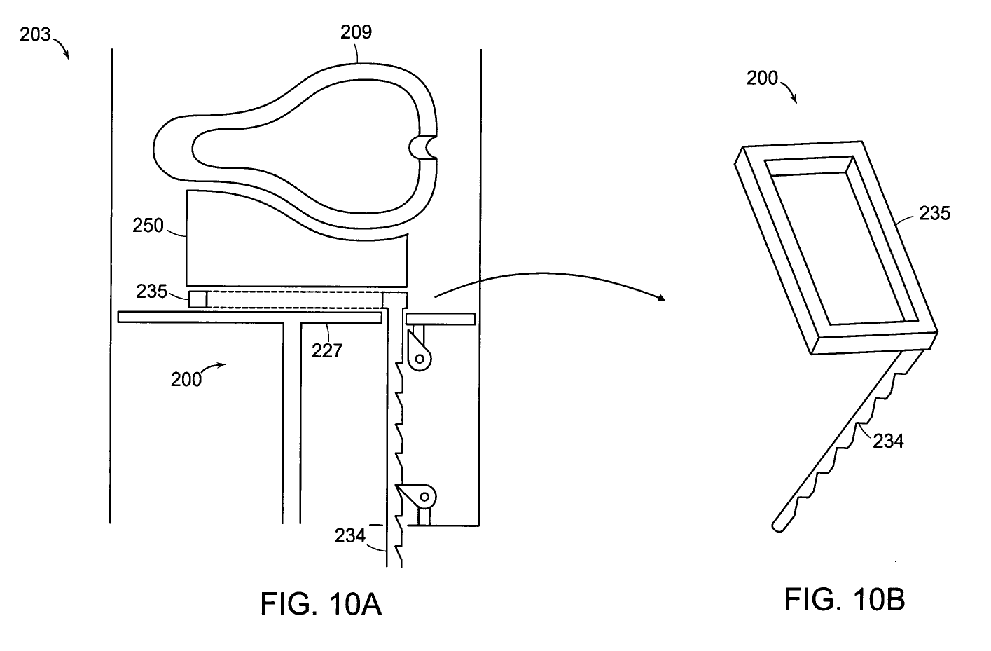

In an alternative embodiment depicted in FIGS. 10A and 10B, a ratcheting mechanism 200 including an ejection pin 234 and a frame 235 for holding a porous surface allows build surface movement to facilitate part extraction. The ratcheting mechanism 200 can be used with any of the three-dimensional printers described herein. In the embodiment shown in FIGS. 10A and 10B, the pin 234 and frame 235 are a single piece. Any of the porous surfaces described hereinabove can be attached to the frame 235, either by welding, fasteners, or other mechanical means, or the frame can have a support structure printed or resting thereon (FIG. 10A). The ejection pin 234 extends through the build surface 227 and engages with the other components of the ratchet mechanism 200, which are coupled to the build surface 227. The operation of the ratchet mechanism 200 is described with respect to FIGS. 11A-11G.

FIGS. 11A-11G depict a pair of spring-loaded pawls 202 that constrain the movement of the pin 234, so that it can only be driven upward relative to the build surface 227 immediately below the bottom of travel of the build surface 227. This mechanism 200 eliminates the need for a separate actuator for the pin 234 and permits the pin 234 to only be slightly longer than the depth of the build chamber 226 in order to lift the top end of the pin 234 to the level of the top of the chamber 226. It is desirable for the printer to be about twice as tall as the maximum build height to accommodate optimally the pin 234. Alternatively, the pin 234 can be actuated or advanced by bottoming out the build surface on the floor of the printer; however, this configuration generally requires the build chamber 26 to have twice the range of motion needed to make a maximum size part, and the printer height is generally required to be about twice that distance.

Moving from FIG. 11A to FIG. 11B, the build surface 227 is lowered to engage the upper pawl 202a on the highest notch 216 on the pin 234. In the embodiment shown, the upper pawl 202a is attached to and extends downwardly from the bottom of the build surface 227. Moving to FIG. 11C, the build surface 227 is raised and the upper pawl 202a carries the pin 234 upward (along with any associated frame 235, porous surface, etc.). The lower pawl 202b is rotated clockwise as the pin 234 slides past. In the embodiment shown, the lower pawl 202b extends upwardly from the bottom of the printer; however, the lower pawl could also extend from a sidewall of the printer enclosure or any other fixed location on the printer. In FIG. 11D, the pin 234 travels far enough so that the lower pawl 202b drops into the next notch 204. The pawls 202 shown can be biased into their associated notches 216 by, for example, a spring; however, the pawls 202 could simply drop into the notches 216 by the force of gravity.

The build surface 227 is again lowered in FIG. 11E, thereby catching the lower pawl 202b and causing the upper pawl 202a to rotate clockwise out of its notch 204. The pin 234 slides relative to the build surface 227. Moving to FIG. 11F, the build surface 227 lowers far enough that the upper pawl 202a engages a second notch 216 in the pin 234. In FIG. 11G, the cycle restarts as shown in FIG. 11C; however, the pin 234 has lifted one notch 216 upward relative to the build surface 227. The cycle can be repeated until the finished part is ejected from the build chamber 226.

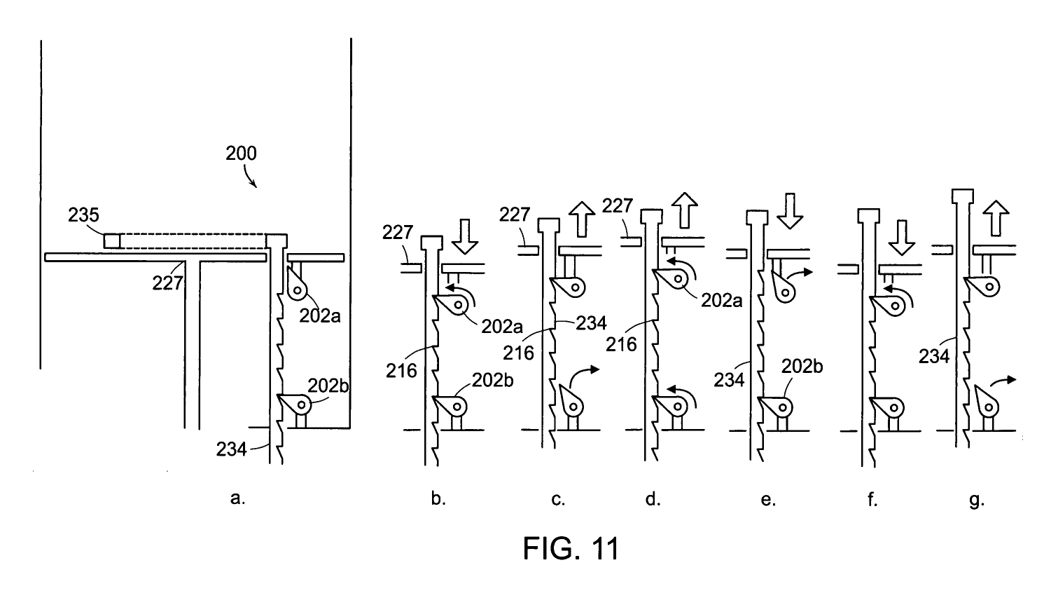

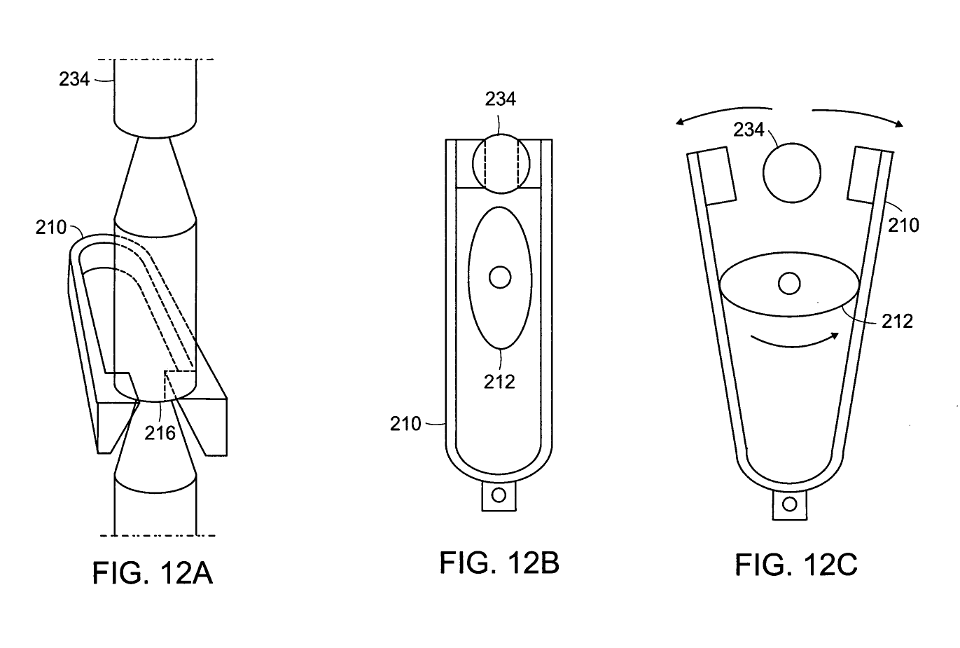

Alternatively, the ratchet mechanism 200 can be modified to use a pair of forceps that pinch the pin, as shown in FIGS. 12A-12C. The spring-loading of the forceps 210 can be provided by the resilience of the forceps themselves, thereby reducing the height and number of parts. Furthermore, a forceps arrangement can be conveniently opened and closed by a rotating cam 212. To retract the ejection mechanism between builds, the ratcheting mechanism 200 is disengaged. A rod with an elliptical cross-section could form the cam 212 and hang from a swivel under the build surface 227 and travel parallel to the ejector pin 234. If the cross-section is uniform along the length of the rod, then it will not matter where the position of the build surface 227 is relative to the ejector pin(s) 234. Rotating the cam 212 will disengage the ratchet mechanism 200 in any position. As shown in FIGS. 12B and 12C, the forceps 210 are shown from above with the cam 212 and ejector pin 234 viewed from one end. In FIG. 12B, the forceps 210 are closed and the jaws engage a notch 216 in the pin 234 (see FIG. 12A). In FIG. 12C, the cam 212 is rotated by 90 degrees, opening the forceps 210 and releasing the ejector pin 234. The elliptical cam 212 can have a uniform elliptical cross-section along its entire length and be the same length as the ejector pin 234; however, the length and cross-sectional shape of the cam 212 may vary to suit a particular application. Other mechanisms for raising and lowering the ejection mechanisms 34, 134, 234 are contemplated and considered within the scope of the invention.

In alternative embodiments, the various concepts disclosed herein can be built into or retrofitted into three-dimensional printers of different configurations. For example, the invention can be incorporated into a radial build machine (U.S. Patent Publication No. 2004/0265413) or a large scale printer (U.S. Patent Publication No. 2005/0280185). These various printers can have a circular (or other non-rectangular shaped) build surface and/or a stationary build surface, where the printing mechanism travels linearly, non-linearly, or both, with respect to the build surface. Generally, the mechanisms described herein work with the different configuration printers by pulling or pushing the part and/or changing a boundary of a build area, so that the finished part(s) are more readily accessed and removed from the unbound powder and machine. In addition, the mechanisms described hereinabove using vibration, air flow, reciprocating motion, etc. can also be used with three-dimensional printers having different configurations.

With respect to a rotary build surface that rotates within the build chamber during printing, a rake-like mechanism, or other porous surface, can be introduced into the build chamber in a substantially radial orientation to collect the finished part(s) as the table is rotated. The unbound powder will pass through the porous surface while the finished part(s) are collected in, for example, the rake-like mechanism. The ejection mechanism can also grasp the parts to remove them from the printing area.

In a printer with a stationary build surface or area, the ejection mechanism can be disposed on a gantry that moves relative to the build area. In some embodiments, the gantry also carries the printing mechanism. The ejection mechanism can be moved relative to the build area to either push or pull the finished part(s) out of the build area. With respect to a large scale machine that creates the build chamber while building the part, as described in U.S. Patent Publication No. 2005/0280185, the ejection mechanism can remove a portion of the boundary (e.g., a wall) of the printed build chamber that surrounds the finished part.

It should be noted that the various embodiments described hereinabove can be used in various combinations to suit a particular application or machine configuration. In addition, the overall size and configuration of the system and its various components can be sized and configured to suit a particular application. A system in accordance with the invention can handle parts of essentially any size.

What is claimed is:

1. An apparatus for extracting an article from a powder bed in a build chamber of a three-dimensional printer, the apparatus comprising:
a mechanism adapted for use with the three-dimensional printer and disposed at least partially within the build chamber and adapted for displacing the article comprising bound powder from the powder bed comprising unbound powder by at least one of:
pushing the article at least partially out of the powder bed;
pulling the article at least partially out of the powder bed; and
changing a boundary of the build chamber to move at least a portion of the unbound powder away from the article.

2. The apparatus of claim 1, wherein the pushing mechanism comprises at least one of a pin, a basket, a grate, a spoon, and a cradle.

3. The apparatus of claim 1, wherein the pulling mechanism comprises at least one of a sling, a basket, a net, a spoon, and a hook.

4. The apparatus of claim 1, wherein the boundary changing mechanism comprises at least a portion of a wall defining the powder bed.

5. The apparatus of claim 1, further comprising at least one of a flow inducer and a vibrator to fluidize at least a portion of the powder bed.

6. The apparatus of claim 1, further comprising a mechanism for imparting reciprocating motion to the article within the powder bed.

7. A method of extracting an article from a powder bed in a build chamber of a three-dimensional printer, the method comprising the steps of:
displacing the article comprising bound powder from the powder bed comprising unbound powder by employing a mechanism adapted for use with the three-dimensional printer and disposed at least partially within the build chamber by at least one of:
push the article at least partially out of the powder bed;
pull the article at least partially out of the powder bed; and
change a boundary of the build chamber to move at least a portion of the unbound powder away from the article; and
removing the article from the three-dimensional printer.

8. The method of claim 7, wherein the push mechanism comprises at least one of a pin, a basket, a grate, a spoon, and a cradle.

9. The method of claim 7, wherein the pull mechanism comprises at least one of a sling, a basket, a net, a spoon, and a hook.

10. The method of claim 7, wherein the boundary change mechanism comprises at least a portion of a wall defining the powder bed.

11. The method of claim 7, further comprising the step of employing at least one of fluidic flow and vibration to fluidize at least a portion of the powder bed while displacing the article.

12. The method of claim 7, further comprising the step of imparting a reciprocating motion to the article within the powder bed.

13. An apparatus for removing a printed article from a three-dimensional printer, the apparatus comprising:
a build chamber disposed within the three-dimensional printer;
a moveable build surface disposed within the build chamber and adapted for receiving unbound powder, portions of layers of the unbound powder being bonded through the action of the three-dimensional printer to produce the printed article; and
an ejection mechanism disposed through at least one of the build surface and a wall of the build chamber,
wherein, the ejection mechanism is adapted for movement relative to at least one of the build surface and the wall of the build chamber.

14. The apparatus of claim 13, wherein the ejection mechanism comprises a ratchet mechanism for causing the movement of the ejection mechanism relative to at least one of the build surface and the wall of the build chamber.

15. The apparatus of claim 13, wherein the ejection mechanism comprises at least one porous surface.

16. An apparatus for removing a printed article from a three-dimensional printer, the apparatus comprising:
a build chamber at least partially disposed within the three-dimensional printer and comprising a moveable build surface and at least one moveable wall, wherein the build chamber is adapted for receiving unbound powder for producing the printed article; and
wherein the at least one moveable wall is separable from the build surface to allow unused powder to exit the chamber.

17. The apparatus of claim 16, wherein the at least one moveable wall is pivotably mounted to the apparatus.

18. The apparatus of claim 16, further comprising a collection chamber disposed below the build surface for receiving the powder exiting from the build chamber.

19. A method for extracting a printed article from a three-dimensional printer, the method comprising:
supporting the printed article within a build chamber with an ejection mechanism, wherein the build chamber is adapted for receiving unbound powder, portions of layers of the unbound powder being bonded through the action of the three-dimensional printer to produce the printed article, and wherein the ejection mechanism is disposed through a build surface located within the build chamber; and
moving at least one of the ejection mechanism and the build surface relative to the other to separate the printed article from unbound powder in the build chamber during the printing process.

20. The method of claim 19, further comprising the step of advancing the ejection mechanism relative to the build surface to advance the printed article beyond a boundary of the build chamber.
